(19) United States
(12) Patent Application Publication
(10) Pub. No.: US 2019/0299680 A1
(43) Pub. Date: Oct. 3, 2019

(54) INKJET PRINTER

(71) Applicant: Oki Data Corporation, Tokyo (JP)

(72) Inventor: Kazuteru KURIHARA, Tokyo (JP)

(21) Appl. No.: 16/352,116

(22) Filed: Mar. 13, 2019

(30) Foreign Application Priority Data
Mar. 27, 2018 (JP) 2018-059663

(51) Int. Cl. B41J 25/00; B41J 2/21

(52) U.S. Cl. CPC B41J 25/006; B41J 2/2103

(57) ABSTRACT

An inkjet printer includes (a) a carriage movable in a main scanning direction; (b) recording heads mounted on the carriage, (c) a carriage drive processing part having a first drive part to move in main scanning direction; (d) a carry processing part having a second drive part for a recoding medium, (e) a head drive processing part driving the recording heads to form a superimposed pattern image that is composed by superimposing one of the color inks and the transparent ink on the recording medium; (f) an image detection processing part detecting dots of the superimposed pattern image; and (g) a head drive condition setting part setting the drive conditions of the recording heads using the detection result of the dots such that a dot diameter and an inter-dot distance, which are present in the superimposed image section of the superimposed pattern image, are substantially equal to each other wherein the inter-dot distance is determined between centers of two dots adjacent side by side in the main scanning direction.

### TECHNICAL FIELD

The present invention relates to an inkjet printer.

### BACKGROUND

Conventionally, in an image forming apparatus such as a printer, a copying machine, a facsimile machine, or a multifunction machine, for example, in an inkjet printer, a carriage is moved along a rail, and inks of various colors are discharged from a plurality of recording heads mounted on the carriage and adhere to a recording medium, and thereby, a color image of characters, pictures, and the like is formed, and printing is performed.

However, a plurality of nozzles are formed in the recording heads, and inks discharged from the nozzles become ink droplets and adhere to the recording medium. Therefore, when viscosity of the inks in the nozzles becomes high or when the inks solidify, clogging occurs in the nozzles and ink discharge failure occurs so that an image cannot be formed with high accuracy. Therefore, in order to determine whether or not the inks are properly discharged from the nozzles, discharge inspection of the nozzles is periodically performed.

The discharge inspection is performed by discharging an ink from a nozzle to form a pattern image on a recording medium and by detecting dots of the pattern image using an optical sensor as a density detector. Thereby, whether or not missing dots have occurred is determined.

In this case, for example, in a color inkjet printer in which an image is formed using an ink of which color is transparent (hereinafter, referred to as “transparent color”) in order to improve image quality in addition to inks of black, yellow, magenta and cyan colors (hereinafter, referred to as “color inks”), for recording heads discharging the color inks, whether or not missing dots have occurred can be determined by forming pattern images of the respective colors and detecting dots of the pattern images. However, for a recording head discharging the transparent ink, it is difficult to detect dots of a pattern image using an optical sensor and whether or not missing dots have occurred cannot be determined.

Therefore, an inkjet printer is provided in which, for a recording head that discharges a transparent ink, after forming a pattern image of the transparent ink on a recording medium, a pattern image formed by discharging a color ink from another recording head that discharges the color ink is superimposed on the pattern image of the transparent ink, and thereby, a pattern image (hereinafter, referred to as a “superimposed pattern image”) of the transparent ink and the color ink is formed, and dots of the superimposed pattern image are detected by an optical sensor and whether or not missing dots have occurred is determined (for example, see Patent Document 1).

In this case, when the color ink adheres to a dot formed by adhesion of the transparent ink, the color ink blurs and spreads on the recording medium, and thus, a diameter of a dot formed of the transparent ink and the color ink is larger than a diameter of a dot formed of the color ink only.

Therefore, by detecting dots having increased diameters in the superimposed pattern image using an optical sensor, whether or not missing dots have occurred can be determined.

Further, in the inkjet printer, by setting a resolution when the pattern image of the color ink is superimposed on the pattern image of the transparent ink lower than a resolution when the pattern image of the transparent ink is formed, a difference in color between a portion formed by the transparent ink and the color ink and a portion formed by the color ink only in the superimposed pattern image is made clear.

### RELATED ART

JP Patent No. 4403734

However, in the conventional inkjet printer, an amount of the color ink used in forming the superimposed pattern image is reduced, and it is possible that detection sensitivity of the optical sensor is lowered. In this case, whether or not missing dots have occurred cannot be determined with high accuracy. As a result, image quality of the inkjet printer decreases.

Further, in the conventional inkjet printer, it is also possible that the detection sensitivity of the optical sensor is lowered also depending on a dot diameter of the dots of the transparent ink and the color ink formed in the superimposed pattern image, positions at which the dots are formed, that is, dot positions, and the like. In this case, the superimposed pattern image formed on the recording medium cannot be detected with high accuracy. For example, when the carriage is moved back and forth in a main scanning direction, a dot position of a dot formed in a forward path of the carriage and a dot position of a dot formed in a backward path of the carriage cannot be adjusted with high accuracy. As a result, image quality of the inkjet printer decreases.

The present invention is intended to solve the above-described problem of the conventional inkjet printer, and to provide an inkjet printer that allows detection sensitivity of a density detector to be increased and allows image quality to be improved.

### SUMMARY

An inkjet printer, disclosed in the application, includes: (a) a carriage that is arranged movable in a main scanning direction; (b) a plurality of recording heads that are mounted on the carriage, each of which containing one of color inks and a transparent ink; the recording heads being controlled under drive conditions; (c) a carriage drive processing part that has a first drive part for the carriage, causing the first drive part to move the carriage in main scanning direction; (d) a carry processing part that has a second drive part for a recoding medium, causing the second drive part to move the recording medium in a sub-scanning direction, which is orthogonal to the main scanning direction; (e) a head drive processing part that drives the recording heads to form a superimposed pattern image that is composed by superimposing one of the color inks and the transparent ink on the recording medium, wherein a section where the one of the color inks and the transparent ink are actually layered is defined as an superimposed image section; (f) an image detection processing part that detect dots of the superimposed pattern image, creating a detection result of the dots; and (g) a head drive condition setting part that sets the drive conditions of the recording heads using the detection result of the dots such that a dot diameter and an inter-dot distance, which are present in the superimposed image section of the superimposed pattern image, are substantially equal to each other wherein the inter-dot distance is determined between centers of two dots adjacent side by side in the main scanning direction.

According to one preferred embodiment of the invention, an inkjet printer includes: (a) a carriage that is arranged movable in a main scanning direction; (b) a plurality of recording heads that are mounted on the carriage, each of which containing one of color inks and a transparent ink; the recording heads being controlled under drive conditions; (c) a carriage drive processing part that has a first drive part for the carriage, causing the first drive part to move the carriage in main scanning direction; (d) a carry processing part that has a second drive part for a recoding medium, causing the second drive part to move the recording medium in a sub-scanning direction, which is orthogonal to the main scanning direction; (e) a head drive processing part that drives the recording heads to form a superimposed pattern image that is composed by superimposing one of the color inks and the transparent ink on the recording medium, wherein a section where the one of the color inks and the transparent ink are actually layered is defined as an superimposed image section; (f) an image detection processing part that detect dots of the superimposed pattern image, creating a detection result of the dots; and (g) a head drive condition setting part that sets the drive conditions of the recording heads using the detection result of the dots such that a dot diameter and an inter-dot distance, which are present in the superimposed image section of the superimposed pattern image, are substantially equal to each other wherein the inter-dot distance is determined between centers of two dots adjacent side by side in the main scanning direction.

In this case, the dots of the superimposed pattern image formed of the transparent ink and the color ink are detected, and the drive conditions of the recording heads are set such that a dot diameter of the dots formed of the transparent ink and the color ink and an inter-dot distance of the dots formed of the transparent ink are substantially equal to each other. Therefore, the detection sensitivity of the density detector can be increased.

Therefore, the image quality of the inkjet printer can be improved.

### BRIEF DESCRIPTION OF THE DRAWINGS

FIG. 1 is a control block diagram of an inkjet printer in a first embodiment of the present invention.

FIG. 2 is a perspective view of the inkjet printer in the embodiment of the present invention.

FIG. 3 is a conceptual diagram of a main part of the inkjet printer in the embodiment of the present invention.

FIG. 4 illustrates an example of a pattern image of a transparent ink in the embodiment of the present invention.

FIG. 5 illustrates an example of a pattern image of a color ink in the embodiment of the present invention.

FIG. 6 illustrates an example of a superimposed pattern image in the embodiment of the present invention.

FIG. 7 is an enlarged view of the superimposed pattern image in the embodiment of the present invention.

FIG. 8 is a flow diagram illustrating procedures for investigating a relation between a dot diameter and an inter-dot distance of the superimposed pattern image and detection sensitivity of an optical sensor in the embodiment of the present invention.

FIG. 9 illustrates an example of an adjustment pattern image array of the transparent ink in the embodiment of the present invention.

FIG. 10 illustrates an example of an adjustment pattern image array of the color ink in the embodiment of the present invention.

FIG. 11 illustrates an example of a superimposed adjustment pattern image array in the embodiment of the present invention.

FIG. 12 illustrates a relation between a deviation amount and a density average value of images of the superimposed adjustment pattern images in the embodiment of the present invention.

FIG. 13 illustrates relations between the dot diameter and the inter-dot distance and the detection sensitivity of the optical sensor in the embodiment of the present invention.

FIG. 14 illustrates positional relationships among dots.

### DETAILED DESCRIPTION OF THE PREFERRED EMBODIMENTS

In the following, an embodiment of the present invention is described in detail with reference to the drawings. In this case, an inkjet printer as an image forming apparatus is described.

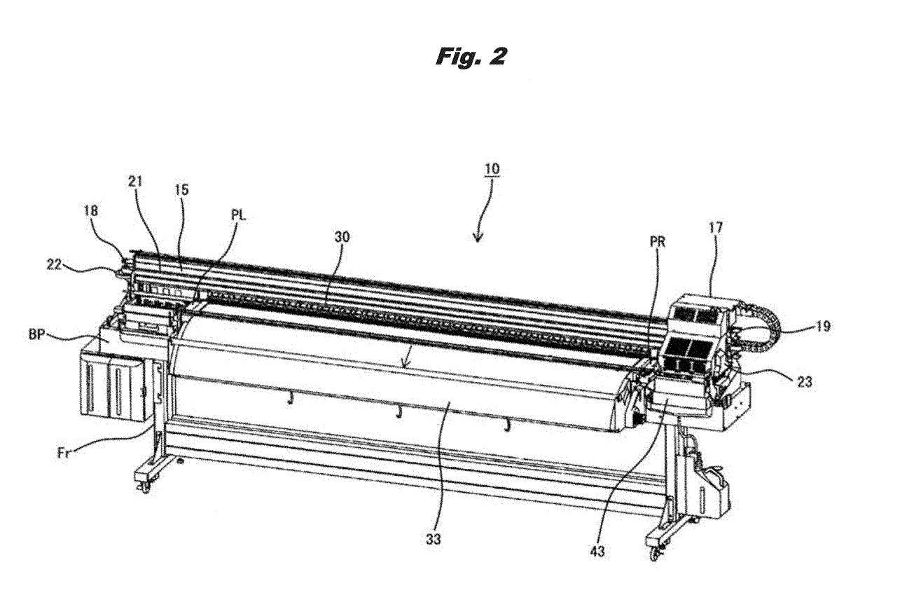

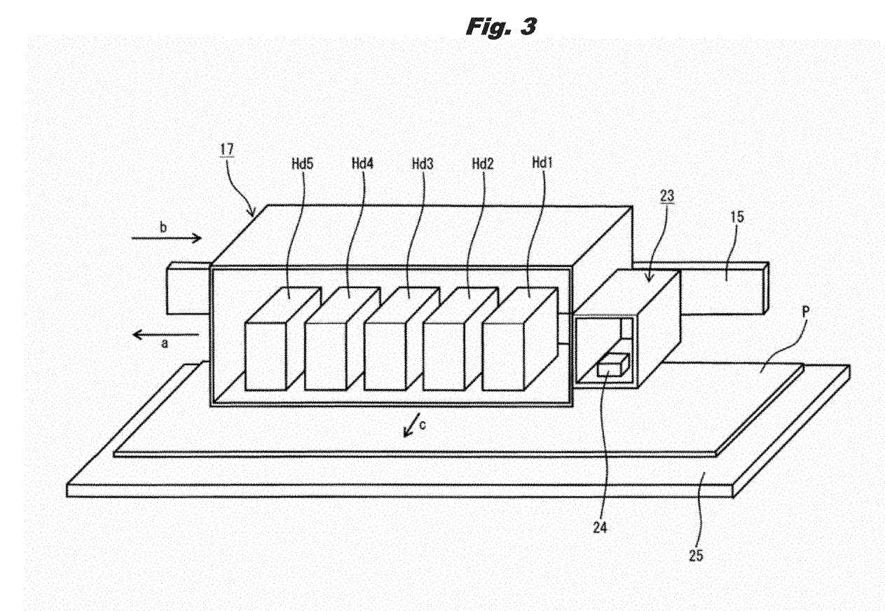

FIG. 2 is a perspective view of an inkjet printer in an embodiment of the present invention. FIG. 3 is a conceptual diagram of a main part of the inkjet printer in the embodiment of the present invention.

In the drawings, “10” denotes an inkjet printer, and “Fr” denotes a frame supporting a main body, that is, an apparatus main body, of the inkjet printer 10. The frame Fr includes a receiving plate BP provided extending from a left end to a right end when the inkjet printer 10 is viewed from a front side (near side in FIG. 2), a frame PL as a first support part formed by rising from the receiving plate BP on a right side at a predetermined distance from the left end of the receiving plate BP, and a frame PR as a second support part formed by rising from the receiving plate BP on a left side at a predetermined distance from the right end of the receiving plate BP.

A rail 15 is arranged (installed) linearly extending between the two ends of the receiving plate BP. Along the rail 15, a carriage 17 is arranged movable in a left-right direction, that is, in a main scanning direction (directions of arrows a and b). Then, in the carriage 17, a plurality of, in the present embodiment, 5 recording heads Hdi (i=1, 2, . . . , 5) are mounted with a surface on which a plurality of nozzles (not illustrated in the drawings) are opened, that is, a nozzle face, facing downward.

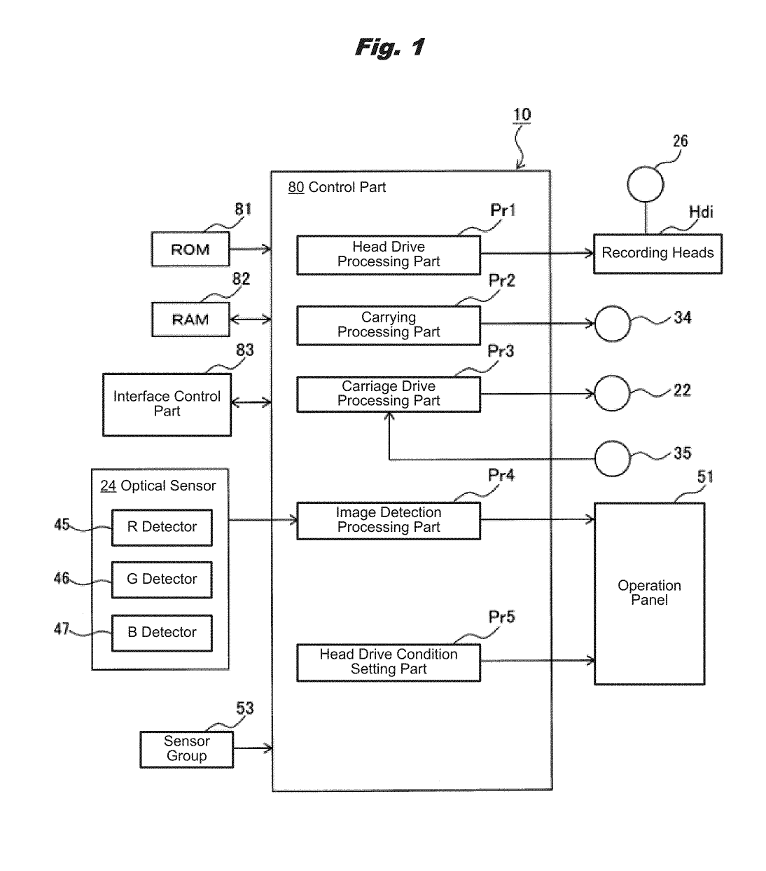

In the recording heads Hdi, a piezoelectric element 26 (FIG. 1) (to be described later) as a drive element is arranged for each of the nozzles. When a predetermined voltage is applied between electrodes provided at both ends of the piezoelectric element 26 for a predetermined time width, in the present embodiment, with a predetermined pulse width, depending on the voltage and the pulse width, the piezoelectric element 26 is expanded or contracted to deform a side wall of a flow path (not illustrated in the drawings) along which ink is fed to the nozzle. As a result, a cross-sectional area of the flow path of the ink changes in accordance with the expansion or contraction of the piezoelectric element 26, and the ink in an amount corresponding to the change in the cross-sectional area becomes ink droplets and is discharged from the nozzle.

In the present embodiment, color inks of black, yellow, magenta and cyan colors are respectively discharged from the nozzles of the recording heads Hd1-Hd4, and a transparent ink is discharged from the nozzle of the recording head Hd5. With the color inks, a color image is formed on a recording medium P. With the transparent ink, glossiness of the color image is increased or a protective layer is formed on a surface of the color image.

A pulley 18 on a drive side near a left end of the rail 15 and a pulley 19 on a driven side near a right end of the rail 15 are each rotatably arranged. An endless belt 21 is stretched in a travelable manner between the pulleys 18, 19, and the carriage 17 is attached to a predetermined portion of the endless belt 21. A carriage motor 22 as a drive part for moving the carriage is linked to the pulley 18.

Therefore, by driving the carriage motor 22 and causing the endless belt 21 to travel, the carriage 17 can be moved in the main scanning direction, and, along with the movement of the carriage 17, the recording heads Hdi can be moved in the main scanning direction. In this case, the color inks of the colors and the transparent ink are respectively discharged from the nozzles of the recording heads Hdi, and adhere to the recording medium P carried in a direction orthogonal to the movement direction of the carriage 17, that is, in a sub-scanning direction (arrow c direction). As a result, an image of characters, pictures and the like is formed on the recording medium P, and printing is performed. As the recording medium P, in addition to a sheet of paper, a resin film such as a vinyl chloride film or a PET film or the like can be used.

Further, on a right side (home position side) of the carriage 17, a sensor unit 23 is attached. In the sensor unit 23, a reflection type optical sensor 24 as a pixel detector and a density detector is provided. The optical sensor 24 includes an R detector 45 (FIG. 1) as a first color detector, a G detector 46 as a second color detector and a B detector 47 as a third color detector (to be described later). An image density of a cyan color image is detected by the R detector 45. An image density of a magenta color image is detected by the G detector 46. An image density of an image of a yellow color and a black color is detected by the B detector 47. Further, in the present embodiment, in the discharge inspection of the nozzles, in order to determine whether or not the inks are properly discharged from the nozzles, dots forming pixels of a pattern image formed by the recording heads Hdi are detected by the optical sensor 24. Therefore, in this case, dots of the cyan color are detected by the R detector 45, dots of the magenta color are detected by the G detector 46, and dots of the yellow color and dots of the black color are detected by the B detector 47.

A linear scale (not illustrated in the drawings) is linearly arranged along the rail 15 and in parallel with the rail 15. The scale of the linear scale is optically read by an encoder 35 (FIG. 1) (to be described later) arranged in the carriage 17. Based on a sensor output of the encoder 35, a position of the carriage 17 is detected. Further, based on a positional change of the carriage 17 and time, a movement speed of the carriage 17 can be calculated.

Further, a metal platen 25 having a plate-like shape is arranged extending along the rail 15 and in parallel with the rail 15. The platen 25 is arranged between the frames PL, PR on the receiving plate BP and supports the recording medium P carried on the platen 25.

A plurality of suction holes (not illustrated in the drawings) are formed in the platen 25. Below the platen 25, an air suction device (not illustrated in the drawings) for drawing the recording medium P to the platen 25 by a negative pressure is arranged. The air suction device has a suction fan, and air is sucked via the suction holes by the fan, and the recording medium P is supported flat by the platen 25.

Further, a pre-guide (not illustrated in the drawings) as a first medium guide part is arranged on a rear side of the platen 25. The pre-guide guides the recording medium P fed out from a feed roll (not illustrated in the drawings) to the platen 25. Therefore, a carrying roller pair 30 as a carrying member is rotatably arranged between the pre-guide and the platen 25 in a carrying direction of the recording medium P.

The carrying roller pair 30 is arranged adjacent to the platen 25, and includes a carrying roller as a first roller which is rotatably arranged at multiple places in the main scanning direction of carriage 17, and a pinch roller as a second roller which is rotatably arranged above the carrying roller and presses the recording medium P against the carrying roller. When a carrying motor 34 as a drive part for carrying (to be described later) is driven and the carrying roller is rotated, the pinch roller is rotated with the rotation.

As a result, the recording medium P is fed out from the feed roll in a state of being sandwiched between the carrying roller and the pinch roller, and is carried along the pre-guide and is fed onto the platen 25. Then, the recording medium P and the nozzle face of the recording heads Hdi are caused to oppose each other, and the inks are discharged from the nozzles and adhere to the recording medium P.

Further, an after guide 33 as a second medium guide part for guiding and ejecting the recording medium P after printing is performed is arranged on a front side of the platen 25. The after guide 33 has a curved shape in order to guide downward the recording medium P ejected in a horizontal direction from the platen 25.

Therefore, the recording medium P fed out from the feed roll is guided by the pre-guide and is fed to the platen 25, and, on the platen 25, the inks discharged from the nozzles of the recording heads Hdi adhere to the recording medium P, and printing is performed. After printing is performed, the recording medium P is guided by the after guide 33 and is carried to a winding device (not illustrated in the drawings) to be wound up.

The inks adhere to the recording medium P immediately after printing is performed. When the recording medium P is ejected from the platen 25 and is wound up by the winding device before the inks are dried, the recording medium P is stained with the inks.

In the present embodiment, in order to dry the inks on the recording medium P and to fuse the inks onto the recording medium P, a heater (not illustrated in the drawings) as a first heating body is embedded in the platen 25, and heaters (not illustrated in the drawings) as second and third heating bodies are respectively attached to back sides of the pre-guide and the after guide 33, and the heaters are each covered with an aluminum sheet. Therefore, the recording medium P carried on the pre-guide, the platen 25 and the after guide 33 is heated by the heaters.

In the present embodiment, since the rail 15 is arranged between the two ends of the receiving plate BP and the platen 25 is arranged between the frames PL, PR, the discharge of inks, that is, the recording, by the recording heads Hdi is performed when the carriage 17 is being moved over the platen 25. Either when the carriage 17 is placed on a left side of the frame PL or when the carriage 17 is placed on a right side of the frame PR, recording by the recording heads Hdi is not performed.

Therefore, in the present embodiment, the right side of the frame PR is set as a home position for performing origin alignment for the position of the carriage 17, and the left side of the frame PL is set as a retreat position for causing the carriage 17 to retreat from platen 25 and to turn back.

However, the plurality of nozzles are formed in the recording heads Hdi, and the inks discharged from the nozzles become ink droplets and adhere to the recording medium. Therefore, when viscosity of the inks in the nozzles becomes high or when the inks solidify, clogging occurs in the nozzles and ink discharge failure occurs so that an image cannot be formed with high accuracy.

Therefore, a cap unit 43 as a maintenance device is arranged at the home position. The cap unit 43 covers the nozzle face of the recording heads Hdi with a cap to prevent the viscosity of the inks from rising or to prevent the inks from solidifying in the nozzles when the inkjet printer 10 is not used for a long time.

Further, in order to determine whether or not the inks are properly discharged from the nozzles, discharge inspection of the nozzles is periodically performed.

In the discharge inspection, for the recording heads Hd1-Hd4 of the black, yellow, magenta and cyan colors, the color inks of black, yellow, magenta and cyan colors are respectively discharged from the nozzles to form pattern images of the respective colors on the recording medium P, and dots of the pattern images are detected by the optical sensor 24.

Further, for the recording head Hd5 of the transparent ink, a superimposed pattern image is formed by superimposing a pattern image of a predetermined color ink on a pattern image of the transparent ink, and dots of the superimposed pattern image are detected by the optical sensor 24.

However, when the dots of the superimposed pattern image are detected by the optical sensor 24, when the detection sensitivity of the optical sensor 24 is low, the dots of the superimposed pattern image cannot be detected with high accuracy.

Therefore, in the present embodiment, the detection sensitivity of the optical sensor 24 is increased by driving the recording heads Hdi such that a dot diameter of the dots of the transparent ink and the color ink formed in the superimposed pattern image and an inter-dot distance of the dots are in a predetermined relationship.

Next, a control device of the inkjet printer 10 is described.

FIG. 1 is a control block diagram of the inkjet printer in the first embodiment of the present invention.

In FIG. 1, “80” denotes a control part that controls sequences of the entire inkjet printer 10 and performs print control; “81” denotes a ROM as a first storage device formed of a nonvolatile memory; “82” denotes a RAM as a second storage device formed of a volatile memory; “83” denotes an interface (I/F) control part that receives print data and a control command from a host computer as a host device (not illustrated in the drawings); “Hdi” denotes the recording heads; “26” denotes the piezoelectric elements; “51” denotes an operation panel; “53” denotes a sensor group; “24” denotes the optical sensor; “45” denotes the R detector; “46” denotes the G detector; and “47” denotes the B detector.

The control part 80 includes a CPU as an arithmetic device (not illustrated in the drawings), an input/output port, a timer, and the like, and performs various processes based on programs recorded in the ROM 81. In the ROM 81, in addition to the programs, various initial setting values, data of the pattern images formed on the recording medium P in the discharge inspection, and the like are recorded. In the RAM 82, various kinds of data are temporarily recorded. The RAM 82 also functions as a work area when the CPU performs calculations.

Further, the control part 80 includes a head drive processing part Pr1, a carry processing part Pr2, a carriage drive processing part Pr3, an image detection processing part Pr4, a head drive condition setting part Pr5, and the like.

The head drive processing part Pr1 generates image data based on the print data and the control command sent from the host computer and sends the image data to the recording heads Hdi. Further, the head drive processing part Pr1 reads the data of the pattern images recorded in the ROM 81 and sends the data to the recording heads Hdi. The recording heads Hdi perform recording based on the image data and the data of the pattern images.

The carrying processing part Pr2 drives the carrying motor 34, rotates the carrying roller pair 30 (FIG. 2), and carries the recording medium P in the arrow c direction (FIG. 3).

The carriage drive processing part Pr3 drives the carriage motor 22 by PWM control, causes the endless belt 21 (FIG. 2) to travel, and causes the carriage 17 to move in the directions of the arrows a and b (to reciprocate in the main scanning direction). Therefore, the carriage drive processing part Pr3 reads a target position and a target speed of the carriage 17 from the ROM 81, receives a sensor output of the encoder 35, performs A/D conversion of the sensor output to detect the position of the carriage 17, generates a PWM control signal as a control value, and sends the PWM control signal to the carriage motor 22. The carriage motor 22 receives the PWM control signal and changes a rotation speed in proportion to a duty of the PWM control signal, and accelerates or decelerates the carriage 17 so as to move the carriage 17 to the target position at the target speed. Then, the carriage drive processing part Pr3 sends the position of the carriage 17 to the head drive processing part Pr1. The head drive processing part Pr1 discharges the inks from the nozzles of the recording heads Hdi at a timing calculated based on the image data in accordance with the position of the carriage 17.

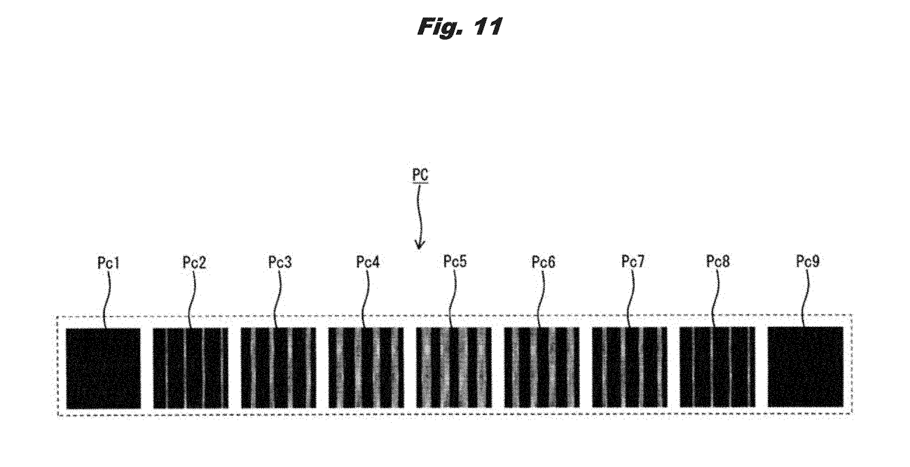

The image detection processing part Pr4 detects dots of the pattern images of the colors and dots of the superimposed pattern image using the optical sensor 24, and also detects an image density of a superimposed adjustment pattern image array PC (FIG. 11) (to be described later).

The head drive condition setting part Pr5 sets the drive conditions of the recording heads Hdi based on the detection sensitivity of the optical sensor 24.

In the optical sensor 24, the R detector 45 detects an image of the cyan color by generating red light and detecting reflected light of the red light; the G detector 46 detects an image of the magenta color by generating green light and detecting reflected light of the green light; and the B detector 48 detects an image of the yellow color and an image of the black color by generating blue light and detecting reflected light of the blue light.

Further, the operation panel 51 includes an LED screen (not illustrated in the drawings) as a display part for displaying a state of the inkjet printer 10, and switches, keys and the like (not illustrated in the drawings) as an operation part allowing an operator to input an instruction to the inkjet printer 10. The dots of the pattern images of the colors, the dots of the superimposed pattern image, the image density of the superimposed adjustment pattern image array PC and the like detected by the image detection processing part Pr4 are displayed on the LED screen. The operator operates the switches, keys and the like to set the drive conditions of the recording heads Hdi. When the operation panel 51 is formed of a touch panel, the display part also functions as an operation part.

The sensor group 53 includes various sensors for monitoring an operation state of the inkjet printer 10, for example, a medium position detection sensor for detecting a position of the recording medium P, a temperature sensor for detecting an environment in which the inkjet printer 10 is placed, a humidity sensor, and the like.

In the present embodiment, when print data and a control command are sent from the host computer via the interface control part 83 to the inkjet printer 10, the carry processing part Pr2 drives the carrying motor 34 to rotate the carrying roller pair 30 to carry the recording medium P in the arrow c direction.

Subsequently, the carriage drive processing part Pr3 drives the carriage motor 22 to cause the endless belt 21 to travel to move the carriage 17 in the directions of the arrows a and b. In this case, the carriage drive processing part Pr3 receives a sensor output from the encoder 35, performs A/D conversion of the sensor output to detect the position of the carriage 17, and sends the position of the carriage 17 to the head drive processing part Pr1. The head drive processing part Pr1 discharges the inks from the nozzles of the recording heads Hdi at a timing calculated based on the image data in accordance with the position of the carriage 17.

However, in the present embodiment, as described above, for the recording heads Hd1-Hd4 of the black, yellow, magenta and cyan colors, when the discharge inspection is performed, the color inks are respectively discharged from the nozzles to form pattern images of the respective colors on the recording medium P, and dots of the pattern images are detected by the optical sensor 24.

Further, in the present embodiment, for the recording head Hd5 of the transparent ink, when the discharge inspection is performed, a superimposed pattern image is formed by superimposing a pattern image of a predetermined color ink on a pattern image of the transparent ink, and dots of the superimposed pattern image are detected by the optical sensor 24.

Next, a change in the dots when the pattern image of the color ink is superimposed on the pattern image of the transparent ink is described.

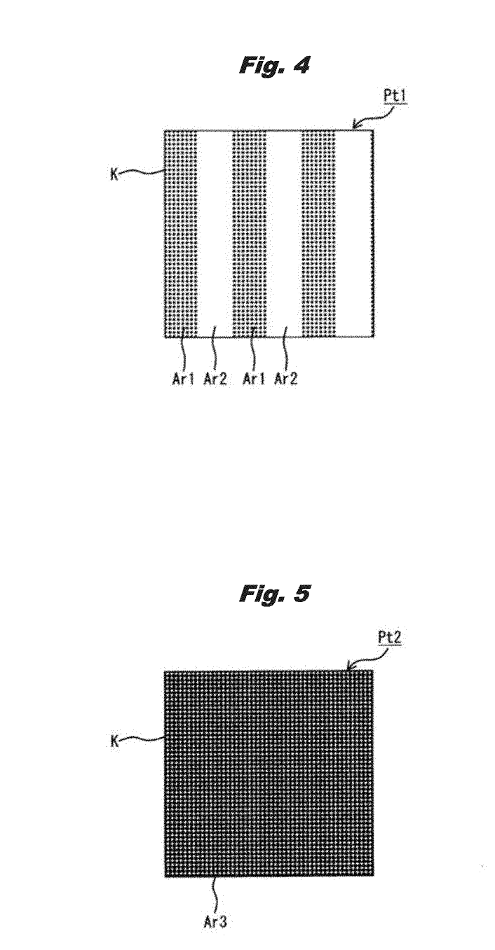

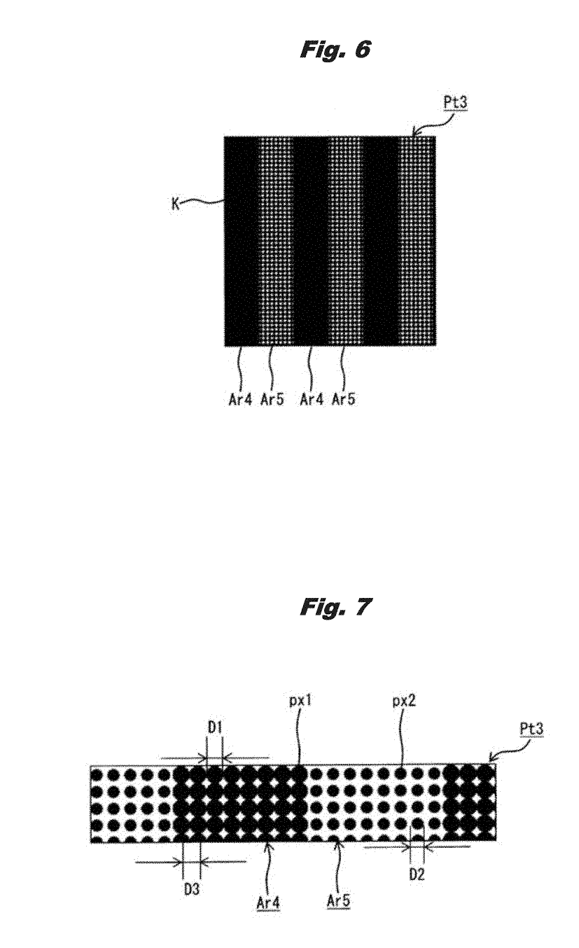

FIG. 4 illustrates an example of the pattern image of the transparent ink in the embodiment of the present invention. FIG. 5 illustrates an example of the pattern image of the color ink in the embodiment of the present invention. FIG. 6 illustrates an example of the superimposed pattern image in the embodiment of the present invention. FIG. 7 is an enlarged view of the superimposed pattern image in the embodiment of the present invention.

In the drawings, “K” denotes an image forming area set at a predetermined place of the recording medium P; “Pt1” denotes the pattern image of the transparent ink formed in the image forming area K; “Pt2” denotes the pattern image of the color ink formed in the image forming area K; and “Pt3” denotes the superimposed pattern image.

In this case, the pattern image Pt1 of the transparent ink is an original pattern image for forming the superimposed pattern image Pt3, and, in the present embodiment, is formed of a stripe-like pattern.

That is, the pattern image Pt1 includes image areas Ar1 that each have a strip-like shape and are formed by discharging the transparent ink from the nozzle of the recording head Hd5 at a predetermined discharging pattern, and non-image areas Ar2 that each have a strip-like shape and are formed by not discharging the transparent ink, and the image areas Ar1 and the non-image areas Ar2 are alternately formed adjacent to each other in the image forming area K.

Further, the pattern image Pt2 of the color ink includes an image area Ar3 that has a rectangular shape and is formed by discharging the color ink from the nozzle of the predetermined recording head at a predetermined discharging pattern. The image area Ar3 is arranged in the entire image forming area K in order to visualize the pattern image Pt1.

Then, the superimposed pattern image Pt3 is formed by superimposing the pattern image Pt2 of the color ink on the pattern image Pt1 of the transparent ink, and image areas Ar4 as superimposed image sections formed of the transparent ink and the color ink and image areas Ar5 as non-superimposed image sections formed of the color ink only are alternately arranged adjacent to each other in the image forming area K.

Dots forming the image areas Ar1, Ar3-Ar5 are formed by adhering ink droplets of the corresponding inks at the same positions in the image forming area K.

However, when the color ink is adhered to the recording medium P after the transparent ink is adhered to the recording medium P, the color ink blurs and spreads on the recording medium P. Therefore, a diameter of each of the dots of the image areas Ar4 formed by the transparent ink and the color ink is larger than a diameter of each of the dots of the image areas Ar5 formed by the color ink only.

That is, as illustrated in FIG. 7, in the superimposed pattern image Pt3, when a dot diameter of each of dots px1 of the image areas Ar4 formed of the transparent ink and the color ink is D1 [μm] and a dot diameter of each of dots px2 of the image areas Ar5 formed of the color ink only is D2 [μm], the dot diameters D1, D2 are such that

D1>D2.

Then, when a distance between the dots px1, that is, an inter-dot distance, is D3 [μm], the dot diameter D1 and the inter-dot distance D3 are substantially equal to each other, that is,

D1≈D3.

It is preferred that the dot diameter D1 is ranged from 100% (exclusive) to 150% (inclusive) with respect to the dot diameter D2.

Further, the inter-dot distance D3 is equal to an inter-dot distance of the dots px2 formed in the image areas Ar5.

The pattern image Pt1 is produced according to a situation of the inkjet printer 10, for example, a type of the recording medium P, and is recorded in the ROM 81. Then, the head drive processing part Pr1 detects the type of the recording medium P, refers to the ROM 81, reads the pattern image Pt1 corresponding to the recording medium P, and forms the pattern image Pt1 onto the recording medium P.

Next, a relation between the dot diameters D1, D2 and the inter-dot distance D3 and the detection sensitivity of the optical sensor 24 when the superimposed pattern image Pt3 is formed based on various pattern images Pt1 is described.

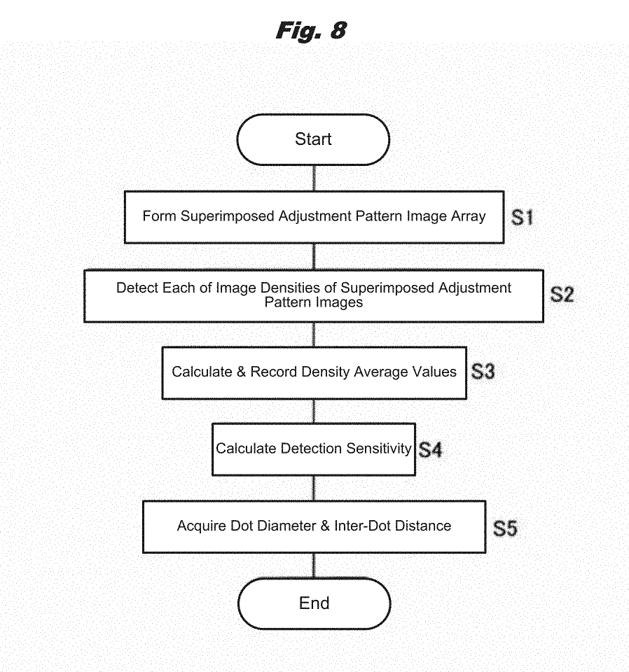

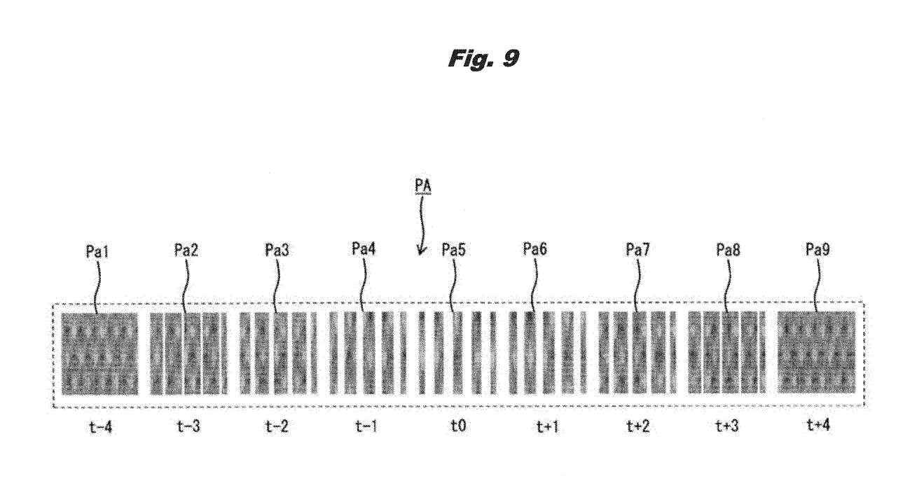

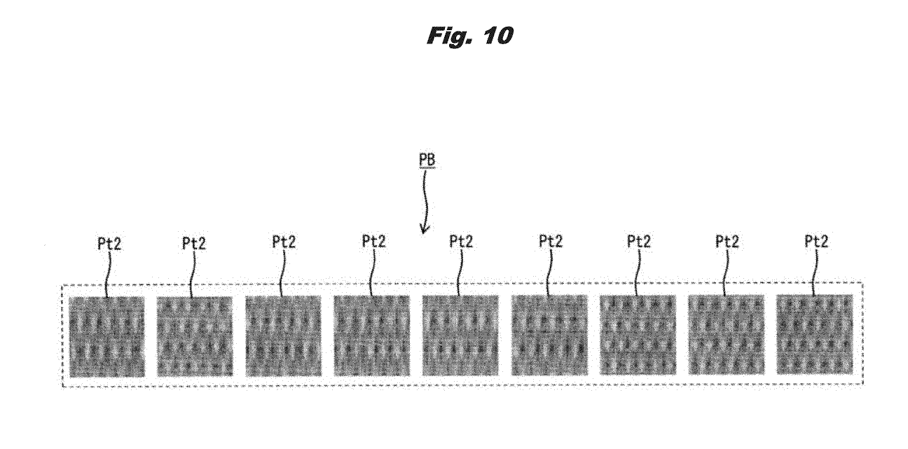

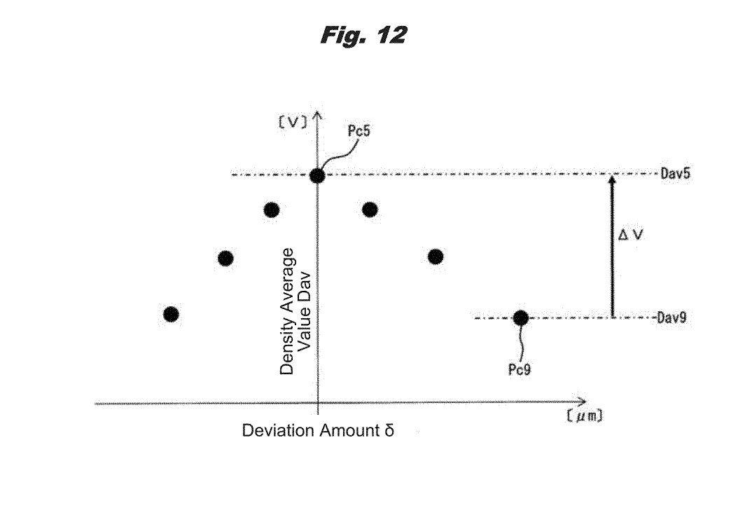

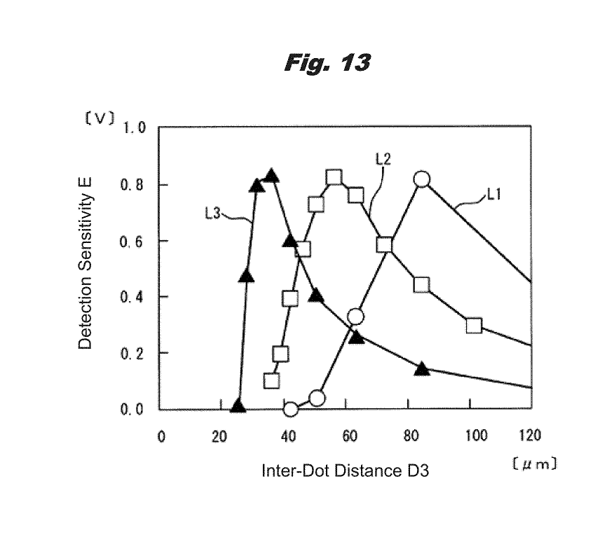

FIG. 8 is a flow diagram illustrating procedures for investigating a relation between the dot diameter and the inter-dot distance of the superimposed pattern image and the detection sensitivity of the optical sensor in the embodiment of the present invention. FIG. 9 illustrates an example of an adjustment pattern image array of the transparent ink in the embodiment of the present invention. FIG. 10 illustrates an example of an adjustment pattern image array of the color ink in the embodiment of the present invention. FIG. 11 illustrates an example of a superimposed adjustment pattern image array in the embodiment of the present invention. FIG. 12 illustrates a relation between a deviation amount and a density average value of the images of the superimposed adjustment pattern images in the embodiment of the present invention. FIG. 13 illustrates relations between the dot diameter and the inter-dot distance and the detection sensitivity of the optical sensor in the embodiment of the present invention. In FIG. 12, the horizontal axis represents the deviation amount δ [μm] and the vertical axis represents the density average value Day [V], and in FIG. 13, the horizontal axis represents the inter-dot distance D3 [μm] and the vertical axis represents the detection sensitivity E [V].

First, in the case where the relation between the dot diameters D1, D2 and the inter-dot distance D3 and the detection sensitivity of the optical sensor 24 when the superimposed pattern image Pt3 is formed is investigated, the carriage drive processing part Pr3 drives the carriage motor 22 to move the carriage 17 back and forth, and the head drive processing part Pr1 drives the recording heads Hdi to process the pattern image Pt1 of the transparent ink illustrated in FIG. 4 to form an adjustment pattern image array PA of the transparent ink including a plurality of, in the present embodiment, 9 pattern images Paj (j=1, 2, . . . , 9) as illustrated in FIG. 9.

Therefore, the carriage drive processing part Pr3 moves the carriage 17 in the arrow a direction, and, in the forward path of the reciprocating movement of the carriage 17, the head drive processing part Pr1 discharges the transparent ink from the recording head Hd5 at a reference timing to form 9 pattern images Pt1 each of which is as illustrated in FIG. 4. Subsequently, the carriage drive processing part Pr3 moves the carriage 17 in the arrow b direction, and, in the backward path of the reciprocating movement of the carriage 17, the head drive processing part Pr1 forms new pattern images Pt1 superimposed on the pattern images Pt1 formed in the forward path, by changing the timing at which the transparent ink is discharged.

That is, when the reference timing is t0, the pattern image Pa5 is formed at the timing t0; the pattern image Pa6 is formed at a timing t+1 later than the timing t0 by a time period τ; the pattern image Pa7 is formed at a timing t+2 later than the timing t0 by a time period 2τ; the pattern image Pa8 is formed at a timing t+3 later than the timing t0 by a time period 3τ; the pattern image Pa9 is formed at a timing t+4 later than the timing t0 by a time period 4τ; the pattern image Pa4 is formed at a timing t−1 earlier than the timing t0 by a time period τ; the pattern image Pa3 is formed at a timing t−2 earlier than the timing t0 by a time period 2τ; the pattern image Pa2 is formed at a timing t−3 earlier than the timing t0 by a time period 3τ; and the pattern image Pa1 is formed at a timing t−4 earlier than the timing t0 by a time period 4τ.

As a result, in the pattern image Pa5, there is no deviation between the pattern image Pt1 formed in the forward path and the pattern image Pt1 formed in the backward path. However, in each of the pattern images Pa1, Pa9, a maximum deviation amount is formed between the pattern image Pt1 formed in the forward path and the pattern image Pt1 formed in the backward path.

Subsequently, the carriage drive processing part Pr3 drives the carriage motor 22 to move the carriage 17 in the arrow a direction, and the head drive processing part Pr1 drives the recording heads Hdi to superimpose an adjustment pattern image array PB of the color ink including nine pieces of pattern images Pt2 as illustrated in FIG. 10 on the adjustment pattern image array PA. The pattern images Pt2 are identical.

In this way, the head drive processing part Pr1 forms a superimposed adjustment pattern image array PC including nine pieces of superimposed pattern images Pcj (j means integers, j=1, 2, . . . , 9) as illustrated in FIG. 11.

However, as described above, the superimposed pattern images Pcj are formed by changing the timing at which the color ink of the pattern images Pt1 in the backward path of the reciprocating movement of the carriage 17 is discharged, and thus have different image densities.

Therefore, in the present embodiment, the image densities of the superimposed pattern images Pcj are detected, and, based on the image densities, the detection sensitivity of the optical sensor 24 is calculated.

Therefore, the carriage drive processing part Pr3 drives the carriage motor 22 to move the carriage 17 in the arrow b direction, and the image detection processing part Pr4 uses the optical sensor 24 to detect the dots of the superimposed adjustment pattern images Pcj and to detect the image densities. In the embodiment, the detection of the dots is performed by detecting a density of the image, which is formed with dots. The density may be referred as a reflection ratio. Specifically, the image detection processing part Pr4 performs multiple times the detection to each of the pattern images Pcj as shifting the detection area. For example, the image detection processing part Pr4 performs the detection as moving the carriage in order to run the sensor over one of the patterns. Given that one pattern is in a square of which one side has 15 mm and the sensor has an detection area that is a circular with 10 mm diameter, ten sections having 4 mm length including the center of the pattern (or 2 mm sections at the both sides in the carriage moving direction) are chosen and detected, obtaining the average value and the average value is regarded as the detection value of the patter. Performing the detection under the equal condition regarding the detection position, the detection error is set as small as possible.

In the optical sensor 24, the R detector 45 detects the dots of the superimposed pattern images Pcj of the cyan color and detects image densities Drj (j=1, 2, . . . , 9); the G detector 46 detects the dots of the superimposed pattern images Pcj of the magenta color and detects image densities Dgj (j=1, 2, . . . , 9); and the B detector 48 detects the dots of the superimposed pattern images Pcj of the yellow and black colors and detects image densities Dbj (j=1, 2, . . . , 9).

Then, the image detection processing part Pr4 uses the optical sensor 24 to detect, multiple times, the image densities of the superimposed adjustment pattern image array PC, and calculates average values of the image densities Drj, Dgj, Dbj of the superimposed pattern images Pcj detected by the R detector 45, the G detector 46 and the B detector 47, and records the results as density average values Davj (j=1, 2, . . . , 9) in the ROM 81. As noted above, the image densities are detected multiple times to each of the image patterns in order to eliminate the detection error as much.

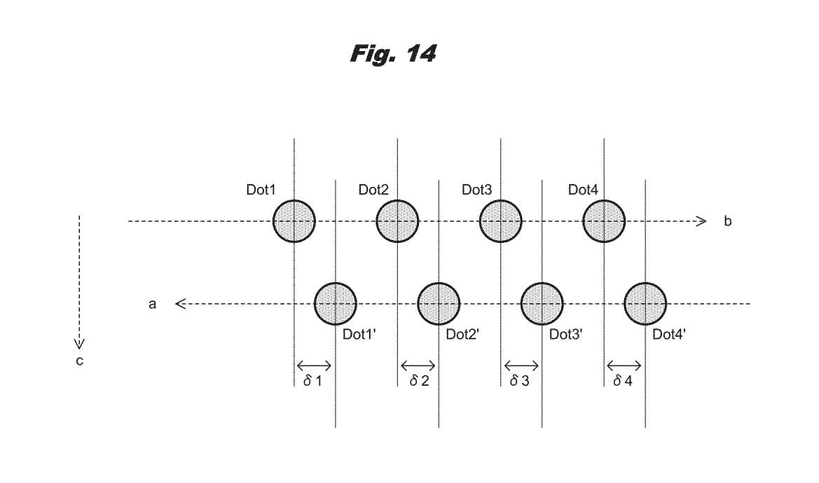

However, in the present embodiment, when the deviation amount between the pattern image Pt1 formed in the forward path and the pattern image Pt1 formed in the backward path when the adjustment pattern image array PA of the transparent ink is formed is δ, the density average values Davj of the superimposed pattern images Pcj are read from the ROM 81, and, based on the density average values Davj and the deviation amount δ, the detection sensitivity E of the optical sensor 24 is calculated. The density average values are obtained for each of the pattern images. FIG. 14 explains the deviation amounts δ. In the drawing, four dots (Dot1-Dot4) are aligned in rightward path (b), which is the forward path. In one step low level in direction (c), there are four dots (Dot1′ to Dot4′), which are aligned in leftward path (a), which is the backward path. The rightward and leftward paths (a) and (b) correspond to the main scanning direction. Direction (c) corresponds to the sub-scanning direction. In the view of sub-scanning direction (c), Dot1 and Dot1′ has a deviation amount δ1, which is caused by a discharge timing for Dot1′ is made earlier than that for Dot1. In the same fashion, deviation amounts δ2-δ4 are made.

That is, in FIG. 12, when a differential voltage representing a density difference between the smallest density average value Dav9 [V] of the superimposed pattern image Pc5 and the largest density average value Dav5 [V] of the superimposed pattern image Pc5 among the density average values Davj of the superimposed pattern images Pcj is ΔV [V], the detection sensitivity E of the optical sensor 24 can be expressed as E=ΔV [V]. In the embodiment, Dav5 of Pc5 was determined as the largest, and Dav9 of Pc9 was determined as the smallest among all nine density average values Dav1 to Dav9. In order to simplify the explanation, FIG. 12 shows only seven dots for the density average values not nine dots that exactly correspond to the nine pattern images Pc1 to Pc9 in FIG. 11.

Therefore, when a plurality of superimposed adjustment pattern image arrays PC are formed by making different the drive condition of the recording head Hd5 when the pattern images Paj of the adjustment pattern image array PA are formed and the drive conditions of the recording heads Hd1-Hd4 when the pattern images Pt2 of the color ink are superimposed on the pattern images Paj, an operator can measure and detect the dot diameter D1 [μm] (FIG. 7) and the inter-dot distance D3 [μm] with respect to the 9 superimposed pattern images Pcj of each of the superimposed adjustment pattern image arrays PC.

The drive conditions of the recording heads Hdi each include a voltage applied between the electrodes of the piezoelectric element 26 (FIG. 1), a pulse width which is a time width in which the voltage is applied to the piezoelectric element 26, and a timing at which the voltage is applied to the piezoelectric element 26.

Then, when the detection sensitivity E [V] calculated based on the density average values Davj and the deviation amounts 6 of the superimposed pattern images Pcj and the dot diameter D1 [μm] and the inter-dot distance D3 [μm] measured with respect to the superimposed pattern images Pcj are plotted, characteristic lines L1-L3 as illustrated in FIG. 13 can be obtained.

The characteristic line L1 shows a relation between the inter-dot distance D3 [μm] and the detection sensitivity E [V] when the dot diameter D1 is 80 [μm]; the characteristic line L2 shows a relation between the inter-dot distance D3 [μm] and the detection sensitivity E [V] when the dot diameter D1 is 60 [μm]; and the characteristic line L3 shows a relation between the inter-dot distance D3 [μm] and the detection sensitivity E [V] when the dot diameter D1 is 40 [μm].

From the characteristic lines L1-L3, it is seen that, when the dot diameter D1 and the inter-dot distance D3 are set such that D1≈D3 [μm], the detection sensitivity E of the optical sensor 24 takes a peak value. In this case, when the dot diameter D1 and the inter-dot distance D3 are set such that

0.8×D3≤D1≤1.2×D3 [μm],

and preferably,

0.9×D3≤D1≤1.1=D3 [μm],

the detection sensitivity E [V] can be increased.

Therefore, the head drive condition setting part Pr5 performs printing by setting the drive conditions of the recording heads Hdi, in the present embodiment, by setting the voltage or the pulse width applied to the piezoelectric element 26 of the recording head Hd5 when the pattern image Paj of the transparent ink is formed and when the pattern image Pt2 of the color ink is superimposed on the pattern image Paj to a predetermined value, or by setting the timing at which the voltage is applied to the piezoelectric element 26 to a predetermined value, and forms the superimposed pattern images Pcj, and, based on the superimposed pattern images Pcj, sets the dot diameter D1 and the inter-dot distance D3 to be substantially equal to each other, that is,

D1≈D3.

In this way, in the present embodiment, the dots px1 of the superimposed pattern images Pcj formed of the transparent ink and the color ink and the dots px2 of the superimposed pattern images Pcj formed of the color ink only are detected, and the drive conditions of the recording heads are set such that the dot diameter D1 of the dots px1 formed of the transparent ink and the color ink and the inter-dot distance D3 of the dots px1 are substantially equal to each other. Therefore, the detection sensitivity E of the optical sensor 24 can be increased.

Therefore, whether or not missing dots have occurred can be determined with high accuracy, and the image quality of the inkjet printer 10 can be improved.

In addition, since the superimposed pattern images Pcj formed on the recording medium P can be detected with high accuracy with the high detection sensitivity E, for example, the dot positions of the dots formed in the forward path of the carriage 17 and the dot positions of the dots formed in the backward path of the carriage 17 when the carriage 17 is moved back and forth in the main scanning direction can be adjusted with high accuracy. Therefore, the image quality of the inkjet printer 10 can be further improved.

Next, the flow diagram is described.

Step S1: The head drive processing part Pr1 forms the superimposed adjustment pattern image array PC.

Step S2: The image detection processing part Pr4 detects the image densities of the images of the superimposed pattern images Pcj.

Step S3: The image detection processing part Pr4 calculates the density average values Davj and records the results in the ROM 81.

Step S4: The image detection processing part Pr4 calculates the detection sensitivity E.

Step S5: The operator acquires the dot diameter D1 and the inter-dot distance D3, and the process is terminated.

In the present embodiment, the color inks of the black, yellow, magenta and cyan colors are used. However, in addition to the color inks of the black, yellow, magenta and cyan colors, gray inks produced by lowering pigment concentrations of black, magenta and cyan inks, and light color inks of light magenta and light cyan can also be used in combination. In this case, color reproducibility can be improved, and image quality of an image formed on the recording medium P can be improved.

In the above embodiment, the inkjet printer 10 is described. However, the present invention can also be applied to an image forming apparatus such as a copying machine, a facsimile machine, a multifunction peripheral, or the like.

The present invention is not limited to the above embodiment. Based on the spirit of the present invention, various modifications are possible, which are not to be excluded from the scope of the present invention.

What is claimed is:

1. An inkjet printer, comprising:
(a) a carriage that is arranged movable in a main scanning direction;
(b) a plurality of recording heads that are mounted on the carriage, each of which containing one of color inks and a transparent ink; the recording heads being controlled under drive conditions;
(c) a carriage drive processing part that has a first drive part for the carriage, causing the first drive part to move the carriage in main scanning direction;
(d) a carry processing part that has a second drive part for a recoding medium, causing the second drive part to move the recording medium in a sub-scanning direction, which is orthogonal to the main scanning direction;
(e) a head drive processing part that drives the recording heads to form a superimposed pattern image that is composed by superimposing one of the color inks and the transparent ink on the recording medium, wherein a section where the one of the color inks and the transparent ink are actually layered is defined as an superimposed image section;
(f) an image detection processing part that detect dots of the superimposed pattern image, creating a detection result of the dots; and
(g) a head drive condition setting part that sets the drive conditions of the recording heads using the detection result of the dots such that a dot diameter and an inter-dot distance, which are present in the superimposed image section of the superimposed pattern image, are substantially equal to each other wherein the inter-dot distance is determined between centers of two dots adjacent side by side in the main scanning direction.

2. The inkjet printer according to claim 1, wherein
(a) the superimposed pattern image is composed with
the superimposed image section formed of the transparent ink and the color ink and
a non-superimposed image section formed of the color ink only, and
(b) the image detection processing part detects
dots in the superimposed image section and
dots in the non-superimposed image section, and
(c) the dot diameter in the superimposed image section is larger than the dot diameter in the non-superimposed image section, both of which are calculated by the head drive condition setting part, wherein the dot diameter in the superimposed image section is determined with a dot diameter of the color ink that blurs and spreads on the recording medium when the color ink adheres to the transparent ink.

3. The inkjet printer according to claim 1, wherein
the dot diameter in the superimposed image section is denoted with D1,
the dot diameter in the non-superimposed image section is denoted with D2,
the dot diameter D1 and the dot diameter D2 are satisfied with
1.0×D2<D1≤1.5×D2.

4. The inkjet printer according to claim 2, wherein
the dot diameter in the superimposed image section is denoted with D1 and
an inter-dot distance that is determined by a distance between two of the dots, which are adjacent one another, in the superimposed image section is denoted with D3, and
the dot diameter D1 and the inter-dot distance D3 are satisfied with
0.8×D3≤D1≤1.2×D3.

5. The inkjet printer according to claim 1, wherein
each of the recording heads has a drive element arranged a nozzle thereof, and
the drive conditions of the recording heads are conditions for driving the drive elements.

6. The inkjet printer according to claim 5, wherein
the drive conditions of the recording heads are respectively voltages applied to the drive elements.

7. The inkjet printer according to claim 5, wherein
the drive conditions of the recording heads are respectively time intervals at which voltages are repeatedly applied to the drive elements.

8. The inkjet printer according to claim 5, wherein
the drive conditions of the recording heads are respectively timings at which voltages are applied to the drive elements.

9. The inkjet printer according to claim 1, wherein
(a) while a reciprocating movement of the carriage in the main scanning direction is made over the recording medium in a forward path and a backward path, which is opposite to the forward path, the head drive processing part forms a plurality of pattern images by making timings different from each other, at the timings when the transparent ink is discharged from the recording head in the forward path and the backward path, wherein portions of the superimposed pattern image are composed of the pattern images of the transparent ink,
(b) the image detection processing part is equipped with a density detector that detects image densities of the superimposed pattern images,
(c) the image detection processing part calculates detection sensitivity of the density detector based on the image densities, and
(d) the dot diameter and the inter-dot distance are determined to be values when the detection sensitivity of the density detector takes a peak value.

10. The inkjet printer according to claim 9, wherein
in the pattern images, the superimposed image sections and the non-superimposed image sections have strip-like shapes are alternately arranged in the main scanning direction.
